(19) United States
(12) Patent Application Publication
(10) Pub. No.: US 2002/0054215 A1
(43) Pub. Date: May 9, 2002

(54) Image transmission apparatus transmitting image corresponding to terminal

(76) Inventor: Michiko Mizoguchi, Kawasaki (JP)

Correspondence Address: ROSENMAN & COLIN LLP, 575 MADISON AVENUE, NEW YORK, NY, 10022-2585, US

(21) Appl. No.: 09/803,791

(22) Filed: Mar. 12, 2001

(30) Foreign Application Priority Data
Aug. 29, 2000 (JP) 2000-259580

(51) Int. Cl. H04N 7/173

(52) U.S. Cl. 348/211

(57) ABSTRACT

An image transmission apparatus, a router and a plurality of terminals are provided in an image transmission system. The image transmission apparatus adds screening information to image data, and transmits to the router through a network. The router receives the image data from the image transmission apparatus, selects the image data including the screening information corresponding to a network environment of each transmission path, and transmits selected image data to the plurality of terminals through the transmission path. Thus, the image transmission apparatus does not need to transmit a plurality of image data having various data formats, thereby preventing an increase in network traffic. Additionally, each terminal can receive the image data most appropriate for its network environment.

### BACKGROUND OF THE INVENTION

1. Field of the Invention

The present invention relates to a method and an apparatus for transmitting an image. More particularly, the present invention relates to a method, an image transmission apparatus, and a routing apparatus for transmitting an image through an IP (Internet Protocol) network.

2. Description of the Related Art

Recently, a communication network environment has been shifting from line-switch-based communication to IP network communication. With the shift, a demand for image communication on an IP network has been increasing. As long as the communication network environment corresponds to the IP network communication, the image communication may be simply introduced to the communication network environment because of high network connectivity of the IP network. Such image communication can be utilized in wide areas of markets such as remote surveillance and entertainment, since applications of the image communication has been utilized in various operations such as an image transmission from a camera connected to a network to a server, an image transmission from a server to a client terminal, and a real-time image transmission from a camera to a client terminal.

FIG. 1 is a system diagram showing a construction of a conventional network system. The network system shown in FIG. 1 includes a camera 10, an image encoding apparatus 12, routers 14, 15, 16 and 17, client terminals 18, 19 and 20, and a server 21. Image information outputted from the camera 10 is encoded and made into packets by the image encoding apparatus 12. The image encoding apparatus 12, then supplies the image information to the router 14 through a LAN (Local Area Network). Subsequently, the image information is supplied from the router 14 to the routers 15, 16 and 17 through a WAN (Wide Area Network). Then, the image information is supplied from the routers 15, 16 and 17 through the LAN to the client terminals 18, 19 and 20 respectively. Additionally, the server 21 is connected to the router 14 by the LAN, and image data made into IP packets is initially supplied from the server 21 to the router 14, and then through the routers 15, 16 and 17 to the client terminals 18, 19 and 20 respectively.

In a conventional network system, for instance, in the network system shown in FIG. 1, a volume of image data transmitted from such as the image encoding apparatus 12 and the server 21 needs to be set at the time designing the network system. For example, in a case in which the client terminals 18, 19 and 20 receiving the image data from the image encoding apparatus 12 or the server 21 have various network environments in which some of the client terminals can receive a large volume of the image data, and others can only receive a small volume of the image data, the volume of the image data transmitted from the image encoding apparatus 12 and the server 21 must be kept small enough so that all the client terminals can receive the image data, or a plurality of the image data must be transmitted to the client terminals corresponding to each network environment of the client terminals.

FIG. 2 is a diagram showing a format of an IP packet utilized in a conventional image transmission. The format shown in FIG. 2 includes an IP header, a UDP (User Datagram Protocol) header, a RTP (Realtime Transport Protocol) header, and a plurality of MPEG (Moving Picture Experts Group) data having a stream header attached thereto, in order. Each image data is made into packets with a fixed data length in order of creating the image data, and is transmitted being placed on a UDP frame. Setting a volume of the image data transmitted to each client terminal to a volume that a client terminal whose data reception performance is the lowest can receive decreases a quality of a network service to a client terminal that can originally receive a high-quality network service. Accordingly, in order to provide the most appropriate network services to the client terminals, each service corresponding to a network environment of each client terminal, a plurality of image data having various transmission volumes should be transmitted to the client terminals.

FIG. 3 is a system diagram showing a construction of a network system transmitting a plurality of image data having various transmission volumes in a conventional transmission method. A unit shown in FIG. 3 having a same unit number as a unit shown FIG. 1 corresponds to the unit shown in FIG. 1. The image encoding apparatus 12 shown in FIG. 3 includes image encoding units 12a, 12b and 12c. When image data is supplied from the camera 10, the image encoding units 12a, 12b and 12c encode the image data differently from each other to obtain a plurality of image data having various transmission volumes, and supply the plurality of image data to the router 14. For instance, the image encoding unit 12a outputs an IP packet including only an I (Intraframe) picture of an MPEG, and the image encoding unit 12b outputs an IP packet including the I-picture and a P (Predictive) picture of the MPEG. The image encoding unit 12c outputs an IP packet including the I-picture, the P-picture, and a B (Bidirectional) picture of the MPEG.

The router 14 transmits the image data having various transmission volumes to the routers 15, 16 and 17, each image data corresponding to a communication capacity of the WAN connecting the router 14 and each of the routers 15, 16 and 17. In other words, the router 14 transmits image data whose destination is the client terminal 18 by a large transmission volume to the router 15 having a network environment in which the communication capacity of the WAN is the largest among the WANs connecting the routers 15, 16 and 17 to the router 14. The router 14 transmits image data whose destination is the client terminal 19 by a medium transmission volume to the router 19 having a network environment in which the communication capacity of the WAN is medium. Additionally, the router 14 transmits image data whose destination is the client terminal 20 by a small transmission volume to the router 20 having a network environment in which the communication capacity of the WAN is the smallest. Taking the above-described steps for transmitting the image data having various transmission volumes to the routers 15, 16 and 17 causes a problem in which a load on the image encoding apparatus 12 increases. In addition, communication traffic of networks including the LAN and the WAN, especially, the LAN located between the image encoding apparatus 12 and the server 21 increases.

### SUMMARY OF THE INVENTION

Accordingly, it is a general object of the present invention to provide a method and an apparatus for transmitting an image. A more particular object of the present invention is to provide a method and an apparatus for transmitting an image corresponding to each of a plurality of terminals, thereby preventing increases in network traffic and the load on an image transmission apparatus.

The above-described object of the present invention is achieved by a method of transmitting image data through a network including a router to a plurality of terminals, the method including the steps of adding screening information to the image data for each of a plurality of image types; transmitting the image data of the plurality of image types to the network; receiving the image data of the plurality of image types from the network by the router; selecting, by the router, the image data of an image type corresponding to a network environment of a transmission path based on the screening information; and transmitting the image data of the image type selected by the router to one of the plurality of terminals through the transmission path.

The image transmission apparatus adds the screening information to image data, and transmits the image data to the network. Subsequently, the router having received the image data from the image transmission apparatus through the network selects the image data including the screening information corresponding to the network environment of each transmission path, and transmits the image data to the plurality of terminals through the transmission path. Accordingly, the image transmission apparatus does not need to transmit a plurality of various image data to each of the plurality of terminals, thereby preventing increases in a load on the image transmission apparatus and network traffic. Additionally, each terminal can receive image data most appropriate to its network environment.

Other objects, features and advantages of the present invention will become more apparent from the following detailed description when read in conjunction with the accompanying drawings.

### BRIEF DESCRIPTION OF THE DRAWINGS

FIG. 1 is a system diagram showing a construction of a conventional network system;

FIG. 2 is a diagram showing a format of an IP packet utilized in a conventional image transmission;

FIG. 3 is a system diagram showing a construction of a network system transmitting a plurality of image data having various transmission volumes in a conventional transmission method;

FIG. 4 is a system diagram showing a construction of a network system transmitting the plurality of image data having various transmission volumes, according to the present invention;

FIG. 5 is a diagram showing a format of an IP packet utilized in image transmission, according to a first embodiment of the present invention;

FIGS. 6A through 6F are diagrams showing picture types and a method of mapping pictures to the IP packet for each of ports A, B and C;

FIG. 7 is a block diagram showing a construction of an image encoding apparatus, according to a second embodiment of the present invention;

FIG. 8 is a block diagram showing a construction of a router, according to a third embodiment of the present invention;

FIG. 9 is a flowchart showing a process performed by a client terminal, according to a fourth embodiment of the present invention;

FIG. 10 is a block diagram showing an image decoding apparatus provided in the client terminal, according to a fifth embodiment of the present invention; and

FIGS. 11A, 11B and 11C are diagrams showing a GOB (Group Of Block).

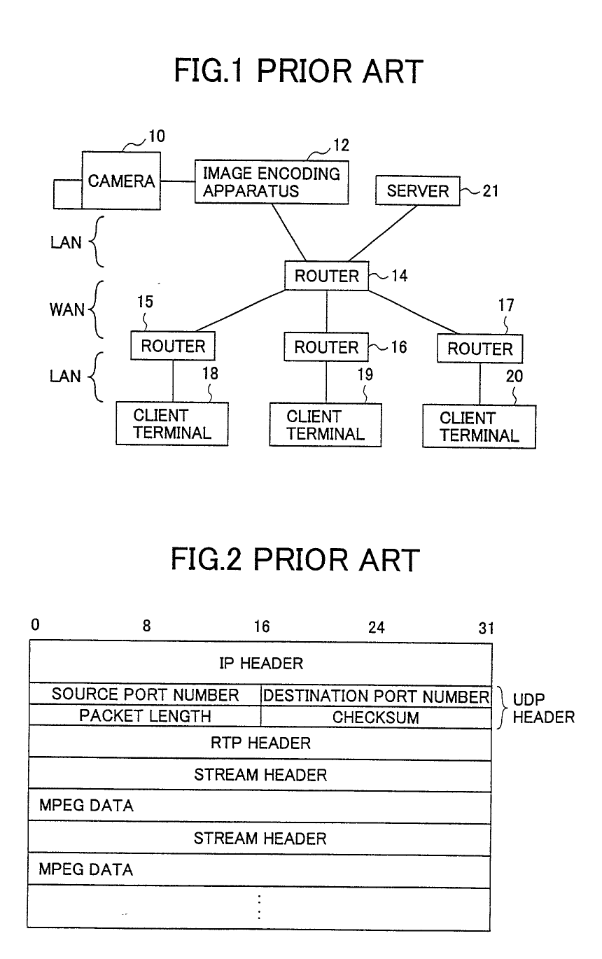

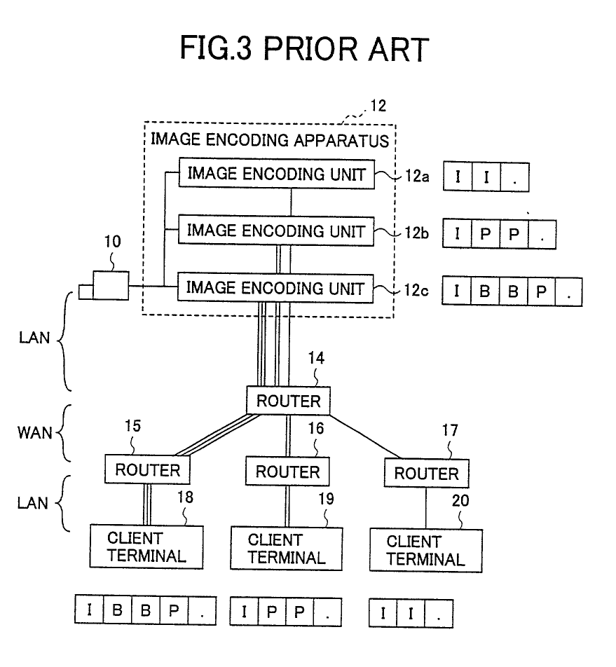

### DESCRIPTION OF THE PREFERRED EMBODIMENTS

A description will now be given of preferred embodiments of the present invention, with reference to the accompanying drawings.

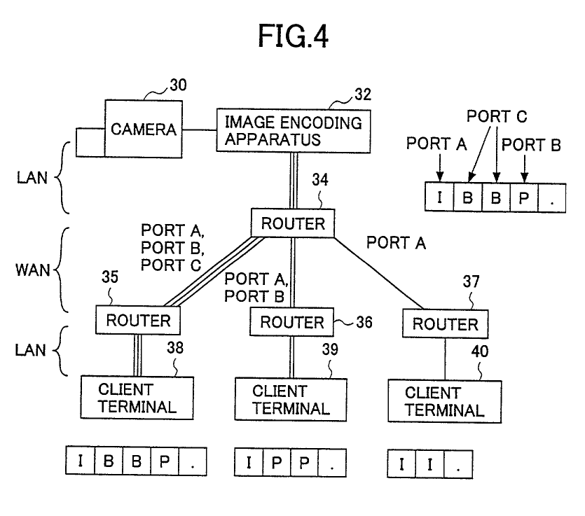

FIG. 4 is a system diagram showing a construction of a network system transmitting a plurality of image data having various transmission volumes, according to the present invention. The network system shown in FIG. 4 includes a camera 30, an image encoding apparatus 32, routers 34, 35, 36 and 37, and client terminals 38, 39 and 40. After receiving image information from the camera 30, the image encoding apparatus 32 outputs image data including an I-picture, a P-picture and a B-picture by executing an MPEG image encoding on the image information, for instance. The image encoding apparatus 32 creates IP packets assigning a source port number and a destination port number as screening information for each of the I-picture, the P-picture and the B-picture differently encoded from each other.

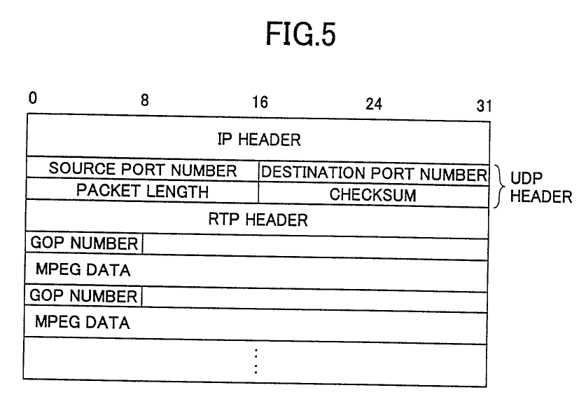

FIG. 5 is a diagram showing a format of an IP packet utilized in image transmission, according to a first embodiment of the present invention. The IP packet shown in FIG. 5 includes an IP header, an UDP header, a RTP header, and a plurality of MPEG data, each MPEG data having a GOP (Group Of Picture) number attached thereto. The UDP header includes a source port number, a destination port number, a packet length and a checksum. A plurality of MPEG data included in a single IP packet have a single picture type that is one of picture types I, B and P.

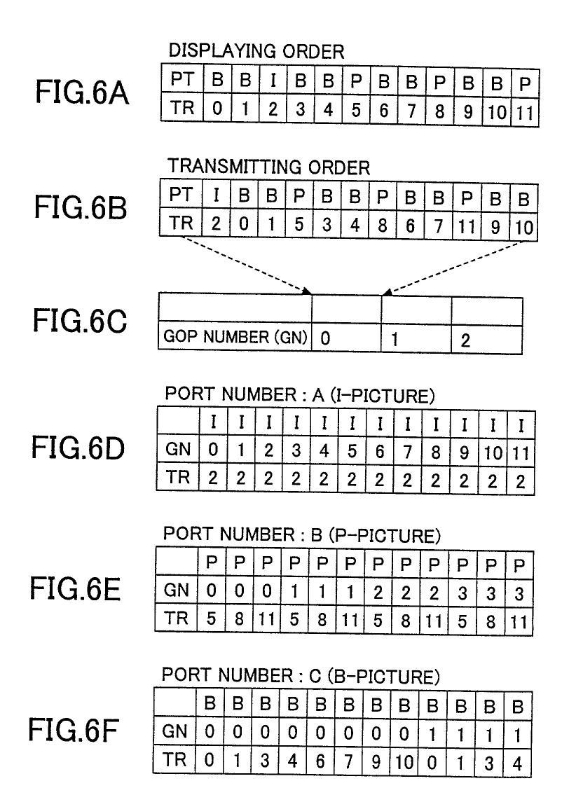

A description will now be given of the picture types and a method of mapping pictures to an IP packet for each port with reference to FIGS. 6A through 6F. FIG. 6A shows the picture types (PT) of MPEG data, and temporal references (TR) indicating a displaying order of pictures at the image encoding apparatus 32. The pictures included in the MPEG data shown in FIG. 6A are, then reordered in a transmitting order as shown in FIG. 6B. The MPEG data shown in FIGS. 6A and 6B corresponds to a GOP number (GN) “0” shown in FIG. 6C. The number of frames corresponds to each GOP is, for instance, less than twenty. An IP packet that is transmitted from the image encoding apparatus 32, and that has a source port number and a destination port number being “A” includes only I-pictures collected from a plurality of MPEG data, as shown in FIG. 6D, each MPEG data having a GOP number different from other MPEG data. Similarly, an IP packet whose source port number and destination port number are set to “B” includes only P-pictures collected from a plurality of MPEG data, as shown in FIG. 6E. Additionally, an IP packet whose source port number and destination port number are set to “c” includes only B-pictures collected from a plurality of MPEG data, as shown in FIG. 6F. One of the I-pictures shown in FIG. 6D, the P-pictures shown in FIG. 6E and the B-pictures shown in FIG. 6F are set as the MPEG data in the IP packet shown in FIG. 5. It should be noted that the MPEG data shown in FIG. 6C is set as the MPEG data in the IP packet shown in FIG. 2.

The router 34 shown in FIG. 4 is connected to the router 35 through a WAN having a large communication capacity, is connected to the router 36 through a WAN having a medium communication capacity, and is connected to the router 37 through a WAN having a small communication capacity. The router 34 has a screening function to pass IP packets having port numbers A, B and C through the router 34 to the router 35, to pass IP packets having port numbers A and B through the router 34 to the router 36, and to pass IP packets having a port number C through the router 34 to the router 37. Therefore, the IP packets having the port number A and including only I-pictures, the IP packets having the port number B and including only P-pictures, and the IP packets having the port number C and including only B-pictures are supplied from the router 34 through the router 35 to the client terminal 38. Similarly, the IP packets having the port number A and including only the I-pictures, and the IP packets having the port number B and including only the P-pictures are supplied from the router 34 through the router 36 to the client terminal 39. Additionally, the IP packets having the port number A and including only the I-pictures are supplied from the router 34 through the router 37 to the client terminal 40.

Each of the client terminals 38, 39 and 40 reorders the IP packets received respectively from the routers 35, 36 and 37. To be concrete, each client terminal reorders the IP packets for each port number by referring to a sequence number included in the RTP header of each IP packet. Additionally, each client terminal decodes MPEG data that has been split into several IP packets by port numbers, based initially on GOP numbers (GN), and then on temporal references (TR). Generally, MPEG data can be decoded by use of only I-pictures, and needs to include the I-pictures for decoding other frames such as P-pictures and B-pictures by referring to the I-pictures. Thus, a client terminal decodes the I-pictures, the P-pictures and the B-pictures, in order.

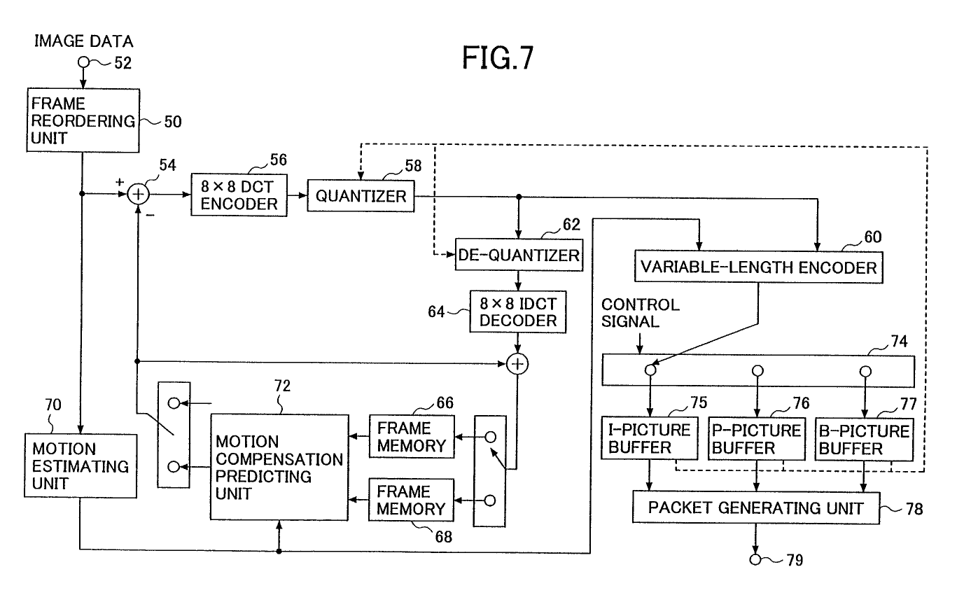

FIG. 7 is a block diagram showing a construction of an image encoding apparatus, according to a second embodiment of the present invention. The image encoding apparatus shown in FIG. 7 includes a frame reordering unit 50, an input terminal 52, a subtractor 54, an 8×8 DCT (Discrete Cosine Transform) encoder 56, a quantizer 58, a variable-length encoder 60, a de-quantizer 62, an 8×8 IDCT (Inverse DCT) decoder 64, frame memories 66 and 68, a motion estimating unit 70, a motion compensation predicting unit 72, a selector 74, an I-picture buffer 75, a P-picture buffer 76, a B-picture buffer 77, a packet generating unit 78 and an output terminal 79.

Pictures or frames are initially supplied to the image encoding apparatus from the input terminal 52 in a displaying order. The frame reordering unit 50 receives the frames from the input terminal 52 in the displaying order, and reorders the frames based on the picture types I, P and B, since B-pictures are encoded by use of frames that are swapped in time. The reordered frames are encoded using a DCT method by a block unit having eight pixels by eight lines, by the 8×8 DCT encoder 56. A DCT coefficient obtained from encoding the reordered frames is quantized by the quantizer 58 in accordance with a target bit and a visual characteristic, and thus spatial information is compressed. Additionally, macro-block encoding information including a motion vector and an encoding mode, and the quantized DCT coefficient are encoded by the variable-length encoder 60 by use of a variable-length code. The variable-length code is used by the variable-length encoder 60 to assign a shorter code to data appearing more frequently.

Additionally, the information quantized by the quantizer 58 is de-quantized by the de-quantizer 62, is decoded by the 8×8 IDCT decoder 64, and then is stored as a reference frame in the frame memories 66 and 68 alternately. The motion estimating unit 70 estimates a motion of the frames, and supplies a motion vector to the variable-length encoder 60 and the motion compensation predicting unit 72. The reference frame stored in the frame memories 66 and 68 is read alternately and supplied to the motion compensation predicting unit 72. The motion compensation predicting unit 72 executes motion prediction based on the reference frame supplied from either of the frame memories 66 and 68, and supplies macro-block image data obtained from the motion prediction to the subtractor 54. The subtractor 54 obtains a prediction error signal by subtracting one of macro-block image data supplied from the frame reordering unit 50 and the macro-block image data supplied from the motion compensation predicting unit 72 from the other. Subsequently, the prediction error signal is supplied to the variable-length encoder 60 through the 8×8 DCT encoder 56 and the quantizer 58.

Variable-length encoded data outputted from the variable-length encoder 60 for each of I-pictures, P-picture and B-pictures is stored respectively in the I-picture buffer 75, the P-picture buffer 76, and the B-picture buffer 77 through the selector 74 that is switched by a control signal based on a picture type. Additionally, the I-picture buffer 75, the P-picture buffer 76 and the B-picture buffer 77 execute quantization control matching a target bit rate by monitoring a bit quantity of a variable-length code of the I-pictures, the P-pictures and the B-pictures, respectively. The I-pictures, the P-pictures and the B-pictures read respectively from the I-picture buffer 75, the P-picture buffer 76, and the B-picture buffer 77 are supplied to the packet generating unit 78. Subsequently, the packet generating unit 78 generates IP packets having the format shown in FIG. 5, and outputs the IP packets from the output terminal 79. It should be noted that the port numbers A, B and C are attached respectively to the IP packets including the I-pictures, the IP packets including the P-pictures, and the IP packets including the B-pictures.

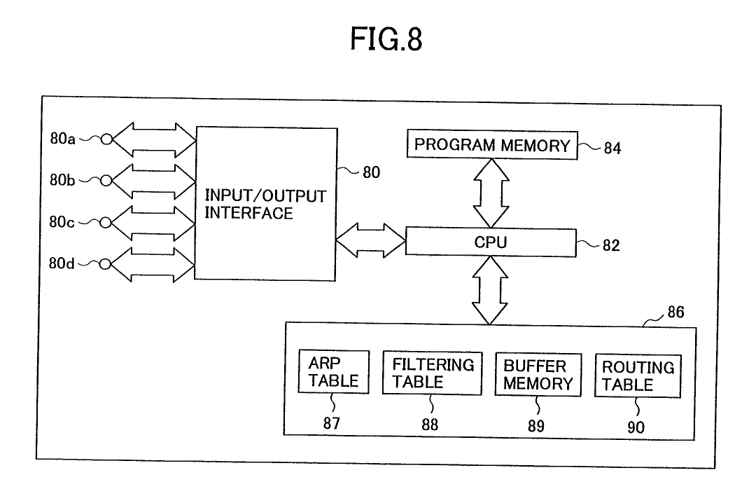

FIG. 8 is a block diagram showing a construction of a router, according to a third embodiment of the present invention. The router shown in FIG. 8 includes an input/output interface 80, input/output ports 80a, 80b, 80c and 80d, a CPU (Central Processing Unit) 82, a program memory 84 and a memory unit 86. The memory unit 86 includes an ARP (Address Resolution Protocol) table 87, a filtering table 88, a buffer memory 89 and a routing table 90. A plurality of the input/output ports 80a, 80b, 80c and 80d are connected to various networks including a WAN and a LAN. An IP packet received at the input/output ports 80a, 80b, 80c or 80d is supplied to the input/output interface 80. The CPU 82 temporarily stores the IP packet received by executing a program stored in the program memory 84, in the buffer memory 89 included in the memory unit 86. Subsequently, the CPU 82 selects one of the input/output ports 80a, 80b, 80c and 80d for transmitting the IP packet by referring to the ARP table 87, the filtering table 88 and the routing table 90 based on an IP header and a UDP header of the IP packet, and transmits the IP packet from the selected input/output port. In the third embodiment, the input/output ports 80a, 80b, 80c and 80d are connected respectively to the image encoding apparatus 32, the router 35, the router 36, and the router 37, for instance.

The filtering table 88 of the router 34 shown in FIG. 4 registers the input/output ports 80b, 80c and 80d, corresponding to the destination port number A (I-picture) included in the UDP header of an IP packet. Similarly, the filtering table 88 registers the input/output ports 80b and 80c, corresponding to the destination port number B (P-picture) included in the UDP header of an IP packet. Additionally, the filtering table 88 registers the input/output port 80b, corresponding to the destination port number C (B-picture) included in the UDP header of an IP packet. Thus, if having received an IP packet at the input/output port 80a from the image encoding apparatus 32, the router 34 transmits an IP packet including I-pictures from the input/output ports 80b, 80c and 80d respectively to the routers 35, 36 and 37, transmits an IP packet including P-pictures from the input/output ports 80b and 80c respectively to the routers 35 and 36, and transmits an IP packet including B-pictures from the input/output port 80b to the router 35.

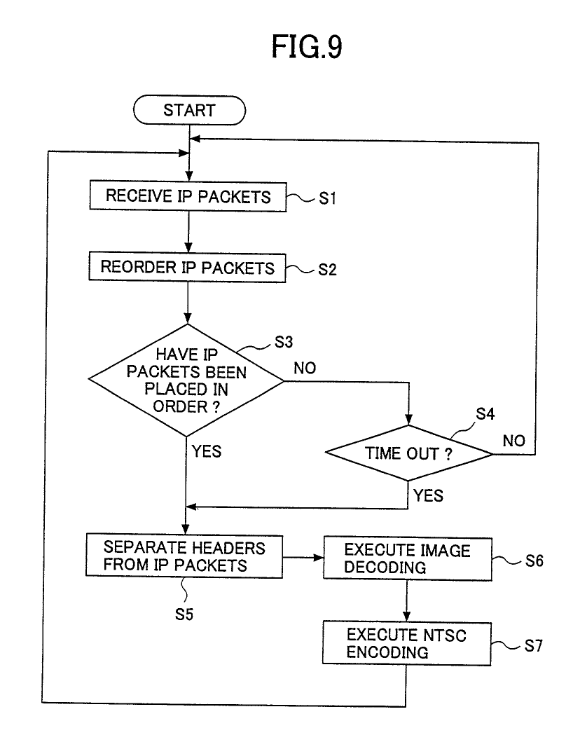

FIG. 9 is a flowchart showing a process performed by a client terminal, according to a fourth embodiment of the present invention. A client terminal such as the client terminals 38, 39 and 40 initially receives IP packets from a network, at a step S1. The client terminal then reorders the IP packets received from the network, at a step S2. To be concrete, the client terminal 38 receives IP packets whose destination port numbers are A, B and C, and reorders I-pictures, P-pictures and B-pictures respectively included in the IP packets having the destination port numbers A, B and C, initially in order of GOP numbers (GN), and then in order of temporal references (TR). The client terminal 39 receives the IP packets whose destination port numbers are A and B, and reorders the I-pictures and the P-pictures included respectively in the IP packets having the destination port numbers A and B, initially in order of the GOP numbers, and then in order of the temporal references. The client terminal 40 receives the IP packet whose destination port number is A, and reorders the I-pictures included in the IP packet, initially in order of the GOP numbers, and then in order of the temporal references.

At a step S3 shown in FIG. 9, the client terminal checks whether the pictures such as the I, P, and B pictures having an identical GOP number have been reordered in order of the temporal references. If it is determined at the step S3 that the pictures have been reordered correctly, the client terminal proceeds to a step S5. If it is determined at the step S3 that the pictures have not been reordered correctly, the client terminal proceeds to a step S4, and checks whether a timer has expired. The client terminal starts the timer every time the client terminal receives an IP packet having a new GOP number, the timer expiring after a fixed period has passed. If it is determined at the step S4 that the timer has not expired yet, the client terminal proceeds to the step S1. If it is determined at the step S4 that the timer has expired, the client terminal proceeds to the step S5. The client terminal separates headers of each IP packet, at the step S5. Subsequently, the client terminal executes MPEG decoding at a step S6, and obtains a color image signal in an NTSC (National Television Standard Committee) form by executing NTSC encoding at a step S7. After the step S7, the client terminal proceeds to the step S1, and repeats the above-described steps on the next image frame.

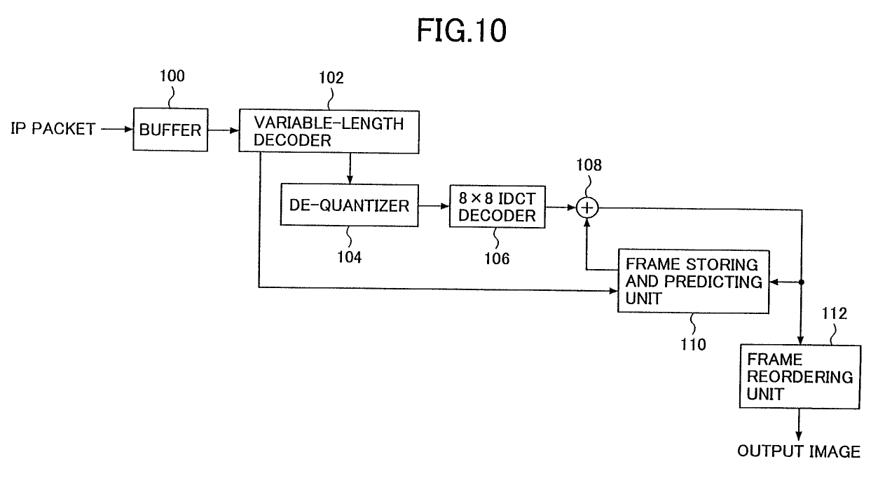

FIG. 10 is a block diagram showing an image decoding apparatus provided in a client terminal, according to a fifth embodiment of the present invention. The image decoding apparatus shown in FIG. 10 includes a buffer 100, a variable-length decoder 102, a de-quantizer 104, an 8×8 IDCT decoder 106, an adder 108, a frame storing and predicting unit 110 and a frame reordering unit 112. The buffer 100 stores IP packets received from a network, in which the IP packets are reordered, at the step S2 shown in FIG. 9. I, P and B pictures of image data are supplied from the buffer 100 to the variable-length decoder 102, where macro-block encoding information is decoded, and where an encoding mode, a motion vector, quantized information and a quantized DCT coefficient are separated. The decoded 8×8 quantized DCT coefficient is de-quantized by the de-quantizer 104 to a DCT coefficient, and then is converted to pixel spatial data by the 8×8 IDCT decoder 106. In an intra encoding mode, the pixel spatial data is outputted from the 8×8 IDCT decoder 106 to the frame reordering unit 112. In a motion compensation predicting mode, the pixel spatial data is added with macro-block data obtained by motion compensation prediction executed by the frame storing and predicting unit 110 at the adder 108, and then is supplied to the frame reordering unit 112. After all the macro blocks in a frame have been decoded, the frame reordering unit 12 reorders frames in an original inputting order, and outputs the frames.

As described above, the image encoding apparatus 32 adds screening information to image data, and transmits the image data to a network. Subsequently, the router 34 having received the image data from the image encoding apparatus 32 through the network selects image data including screening information corresponding to a network environment of each transmission path, and transmits the image data to each transmission path. Accordingly, the image encoding apparatus 32 does not need to transmit a plurality of various image data to each of the plurality of client terminals 38, 39 and 40, thereby preventing increases in a load on the image encoding apparatus 32 and network traffic. Additionally, each client terminal can receive image data most appropriate to its network environment.

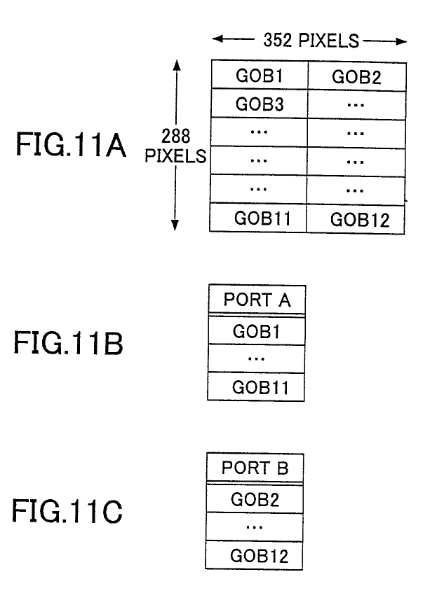

The description has been given of MPEG encoding and decoding in the above embodiments. However, if frames similar to I, P and B pictures exist in a motion-picture compression method H. 263, the same processes as the above-described embodiments may be performed in the H. 263. Additionally, processes similar to the above-described embodiments may be applied to a GOB (Group Of Block) in a motion-picture compression method H. 261. In the H. 261, one frame is divided into twelve blocks having GOB numbers 1 through 12, as shown in FIG. 11A, and thus image data can selected for each client terminal by a block unit, for instance, by assigning odd GOB numbers to a port number A, as shown in FIG. 11B, and by assigning a port number B to even GOB numbers, as shown in FIG. 11C.

The above description is provided in order to enable any person skilled in the art to make and use the invention and sets forth the best mode contemplated by the inventors of carrying out the invention.

The present invention is not limited to the specially disclosed embodiments and variations, and modifications may be made without departing from the scope and spirit of the invention.

The present application is based on Japanese Priority Application No. 2000-259580, filed on Aug. 29, 2000, the entire contents of which are hereby incorporated by reference.

What is claimed is:

1. A method of transmitting image data through a network including a router to a plurality of terminals, said method comprising the steps of:
adding screening information to the image data for each of a plurality of image types;
transmitting the image data of the plurality of image types to the network;
receiving the image data of the plurality of image types from the network by the router;
selecting, by the router, the image data of an image type corresponding to a network environment of a transmission path based on the screening information; and
transmitting the image data of the image type selected by the router to one of the plurality of terminals through said transmission path.

2. A method of transmitting image data through a network including a router to a plurality of terminals, said method comprising the steps of:
adding screening information to the image data;
transmitting the image data to the network;
receiving the image data from the network by the router;
selecting the image data including the screening information corresponding to a network environment of each transmission path by the router; and
transmitting the image data selected by the router to the plurality of terminals through said each transmission path.

3. An image transmission apparatus transmitting image data through a network including a router to a plurality of terminals, said image transmission apparatus comprising a screening-information adding unit adding screening information that is a standard of selecting the image data for each transmission path at the router, to the image data, and then transmitting the image data to the network.

4. The image transmission apparatus as claimed in claim 3, wherein said image data is made into a packet for each image type, and said screening information is a value corresponding to the image type.

5. The image transmission apparatus as claimed in claim 4, wherein said image type is one of an I-picture, a P-picture and a B-picture of an MPEG (Moving Picture Experts Group), said packet is an IP (Internet Protocol) packet, and said screening information is a destination port number included in a UDP (User Datagram Protocol) header of the IP packet.

6. A routing apparatus receiving image data from an image transmission apparatus through a network, and transmitting the image data to a plurality of terminals, said routing apparatus comprising a selecting and transmitting unit selecting the image data including screening information corresponding to a network environment of each transmission path, and transmitting selected image data to the plurality of terminals through said each transmission path.

7. The routing apparatus as claimed in claim 6, wherein said image data is made into a packet for each image type, and said screening information is a value corresponding to the image type.

8. The routing apparatus as claimed in claim 7, wherein said image type is one of an I-picture, a P-picture and a B-picture of an MPEG (Moving Picture Experts Group), said packet is an IP (Internet Protocol) packet, and said screening information is a destination port number included in a UDP (User Datagram Protocol) header of the IP packet.

9. An image transmission system comprising:
an image transmission apparatus adding screening information to image data, and transmitting the image data to a network;
a routing apparatus receiving the image data from the network, selecting the image data including the screening information corresponding to a network environment of each transmission path, and transmitting selected image data to each transmission path; and
a plurality of terminals, each receiving the image data selected by said routing apparatus through a corresponding transmission path.

10. The image transmission system as claimed in claim 9, wherein said image data is made into a packet for each image type, and said screening information is a value corresponding to the image type.

11. The image transmission apparatus as claimed in claim 10, wherein said image type is one of an I-picture, a P-picture and a B-picture of an MPEG (Moving Picture Experts Group), said packet is an IP (Internet Protocol) packet, and said screening information is a destination port number included in a UDP (User Datagram Protocol) header of the IP packet.
